(19) United States
(12) Patent Application Publication
(10) Pub. No.: US 2014/0136365 A1
(43) Pub. Date: May 15, 2014

(54) SUGGESTING EXPENDITURES WITHIN A BUDGET

(71) Applicant: HYAQU, INC., Carmel, CA (US)

(72) Inventor: Edward Nista, Carmel, CA (US)

(73) Assignee: HYAQU, INC., Carmel, CA (US)

(21) Appl. No.: 13/673,870

(22) Filed: Nov. 9, 2012

(51) Int. Cl. G06Q 30/06

(52) U.S. Cl. 705/26.8; 705/26.1

(57) ABSTRACT

Computer-implemented processes, computer storage products, and machines are provided for managing planned expenditures within a budget. Servers store, in association with a set of item(s) of potential expenditure by a user: an item specification that describes at least one item, and an amount of funds that has been designated by the user for the set. The amount might not initially cover a price of the item, but the amount or the item price may be updated such that the amount does cover the price. The servers detect that the amount covers the price, and, in response, generate and send an electronic message that identifies the item and the price. A vendor may change the price such that the price is covered by the designated amount of funds, or additional funds may be added to the amount such that the amount covers the price. Example items goods, services, and/or activities.

### FIELD OF THE INVENTION

The present invention relates to online shopping.

### BACKGROUND

Online shopping systems provide shopping interfaces for browsing items of potential expenditure and purchasing selected items. Items of potential expenditure might include goods, services, or activities that require a user to spend money. A good is an item for which ownership may be transferred to the user in exchange for money. A service is an action that may be performed by a third party for or on behalf of the user in exchange for money. Services may be reserved by purchasing a voucher or pass. An activity is action that may be performed by the user in exchange for money. Activities can be planned by purchasing a ticket or designating funds on a gift card. In various examples, a user could purchase books on Amazon.com or BN.com, furniture on Overstock.com, spa passes or massage passes on Yelp, coupons for moving or cleaning services on Groupon.com, a restaurant gift certificate at Restaurant.com, a flight or hotel booking on Hotels.com, an Alcatraz tour on Alcatraztickets.com, or a gift card on PlasticJungle.com.

An electronic vendor or “vendor” is an entity that lists items for sale on an electronic interface such as a Web site. Electronic vendors such as Amazon.com may sell items originated for sale by the vendor or items for which the vendor serves as an intermediary between other sellers and buyers. For example, individuals may sell items on Amazon.com, and Amazon.com itself may sell items. Vendors typically charge a fee for serving as the intermediary between their customers and other sellers.

Many online shopping systems are designed using the shopping cart model that allows users to add items to their shopping cart and check out by entering payment information. Some online shopping systems, like Amazon's One-Click system, also support express checkout options that allow users to purchase an item based on stored user payment information that was previously entered, without requiring the user to re-enter payment information for each purchase. Some shopping systems have a wish list feature that allows users to add items to a wish list. Later on, items in the wish list may be moved by the user to the shopping cart for purchase. Items typically sit idle in wish lists until they are eventually moved to the shopping cart or deleted by the user.

Most online purchases are made with credit cards. Credit limits on these cards are usually very high, much higher, for example, than a user could pay in any given month or even in a given year. Most online shopping systems are optimized to encourage users to quickly finalize purchases on credit before the users can consider the consequences of such purchases on their lives.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates an example budgeting interface for displaying information about multiple queues and the items in those queues.

FIG. 2 and FIG. 3 illustrate example item selection interfaces for browsing and/or searching for items to add to queues.

FIG. 4 illustrates an example notification message that includes an option to purchase an item.

FIG. 5 illustrates an example shopping and budgeting system in communication with clients and vendors.

FIG. 6 illustrates an example process for triggering an action based on price information for an item and budget information for a queue of items.

FIG. 7 illustrates an example computer system that may be specially configured to perform the techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Computer-implemented processes, computer storage products, and machines are provided for managing planned expenditures within a budget. In one embodiment, server(s) store, in association with a set of item(s) of potential expenditure by a user: (1) an item specification that describes at least one item, and (2) an amount of funds that has been designated by the user for the set. The amount of funds might not initially cover the price of the item, but the amount of funds or the item price may be updated such that the amount does, after the updating, cover the item price. The server(s) detect that the amount covers the price, and, in response, generates and sends an electronic message that identifies the item and the price. In one example, a vendor of the item may offer a discount or a new item price such that, after the discount or price change, the item is covered by the designated amount of funds. The server(s) may store and detect the price change upon receiving updated price information from the vendor. In another example, additional funds may be added to the designated amount of funds such that, after the adding, the designated amount covers the item price. Example items of potential expenditure include goods listed by vendor(s), services listed by vendor(s), and/or activities related to vendor(s).

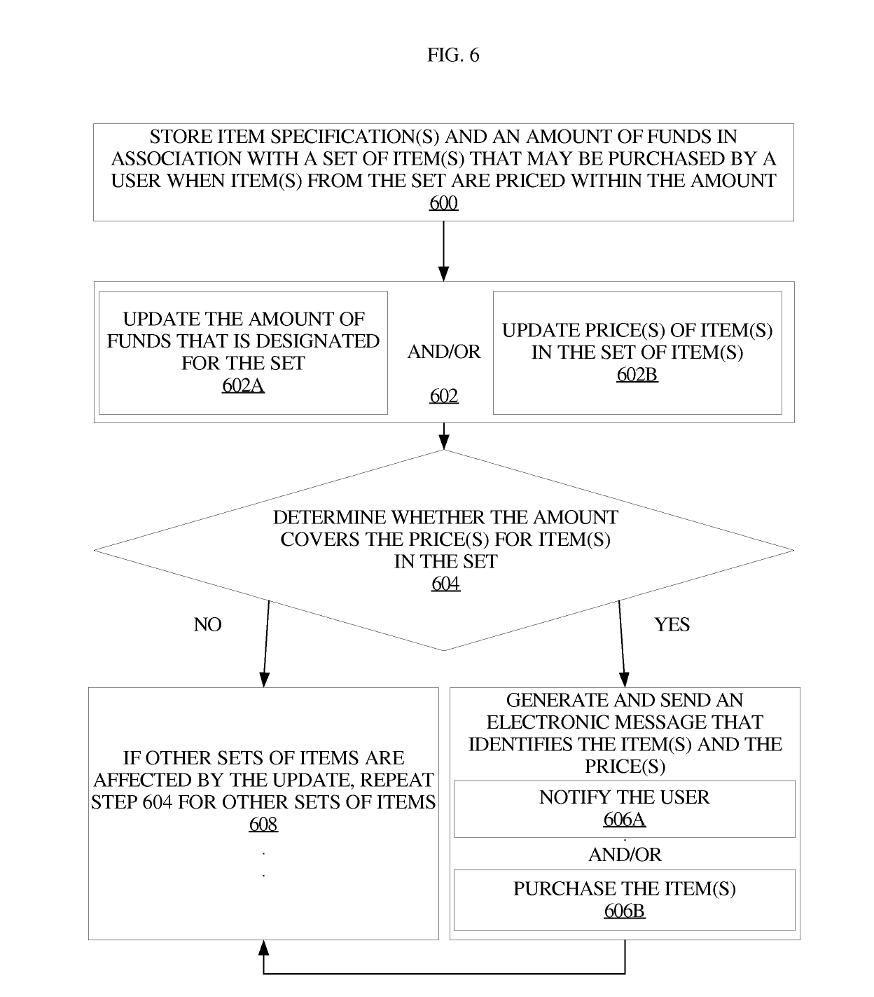

FIG. 6 illustrates an example process for automatically generating and sending an electronic message that identifies item(s) that are covered by a budget and the price(s) of those item(s). In step 600, one or more specially configured machines store, in association with a set of item(s) that may be purchased by a user when the item(s) from the set are priced within an amount of funds, item specification(s) and the amount of funds. In step 602, the specially configured machine(s) may update the amount of funds that is designated for the set (602A) and/or update price(s) of item(s) in the set of item(s) (602B). The process includes, in step 604, determining whether the amount covers the price(s) for item(s) in the set. If so, the specially configured machine(s) generate and send an electronic message that identifies the item(s) and the price(s) in step 606, including optionally notifying the user (606A) and/or automatically purchasing the items (606B). After the set of items has been analyzed in steps 604 and 606 based on the updated information, step 604 is repeated for other items that are affected by the update in step 608. If the update does not trigger an action for a given set of items, the process also proceeds, in step 608, to other sets that may be affected by the update. This process proceeds until all sets that may be affected have been analyzed. These sets may include multiple sets defined by multiple different users.

In one example, the item specification includes criteria for selecting the listed items. For example, the criteria may include search criteria which, when entered on vendor(s) site(s), would result in a list of items that match the criteria. As another example, the criteria may include pricing thresholds, rating thresholds, popularity thresholds, and other filters for excluding non-matching items from the list. As yet another example, the criteria may include information about features that are required or preferred for the items. Alternatively, the item specification may identify a particular item listed by a particular vendor or vendors, or multiple items listed by the vendor or vendors.

The server(s) may generate graphical user interfaces, including a budgeting interface that includes fields for specifying budget categories or queues and amounts of funds that are designated to the categories or queues. The budgeting interface may include options for adding funds to the categories or queues, such as an option to specify a funding source, an option to specify a funding amount, and an option to specify whether funds should be added manually as the user requests to add funds, or periodically according to a user-specified schedule. The amount as updated on one or multiple occurrences as specified by the user using the budgeting interface. The amount as updated may include funds from multiple occurrences of the periodic contribution of funds, and the amount may accumulate over time, optionally toward user-specified goal(s) or price(s) of item(s). The amount may also be updated in response to user-requests to immediately add funds of a user-specified amount to the category or queue.

The graphical user interfaces may also include an item selection interface for displaying item information such as item name, item price, vendor, item rating, vendor rating, and/or other item characteristics to users that are browsing items from electronic vendor(s). The item selection interface may include options to select items that are being browsed by the user. Upon selection, items may be added to categories or queues. Categories or queues may be selected automatically, by the server(s), according to a vendor's shopping category in which the item fits or a default category for the item. In another example, the user may specify, via input accepted by the interface, a category or queue for the item, or select a category or queue from a list of existing or pre-defined categories or queues. The interface may also accept user input specifying a new category or queue, such as a queue named “dad's birthday list.”

When the server(s) detect that the designated amount for a queue or category covers an advertised price for an item in the queue or category, the server may send a notification to the user that identifies the item and price. The notification indicates, to the user, that the item is now covered by the designated amount for the queue or category. The notification may also identify the amount that is designated for the queue or category, and/or a history of recent designated amounts or item prices. The notification may also include an option to purchase the item for the price. When selected, the option causes a message to be sent to the server(s) and/or to a vendor of the item to start or complete purchase of the item.

Alternatively, when the server(s) detect that the designated amount for a queue or category covers an advertised or listed price for an item in the queue or category, the server(s) may send a purchase order to the vendor that identifies the item and price. The purchase order may also include information about the user's funding source that will be used to purchase the item. The purchase order may also include information about a user's physical or electronic shipping address to which the item should be shipped. Upon receipt of the purchase order, the vendor may deduct the purchase price and optionally a shipping amount from the user's funding source, and ship the item to the user at the specified address.

By using the graphical user interfaces that are provided and managed by the server(s), as well as optionally receiving and responding to notifications that are sent to a user by the server, the user may set budgets for items and purchase the items when the items are within the budgets. The user may gradually contribute to funds for specific categories or queues of items, and these gradual contributions may cause the budgeted amount to exceed the price of the item. Alternatively, the price of the item may drop to a price that is covered by the budgeted amount for the category. The server(s) may periodically retrieve item prices from vendor(s), compare the item prices to user budgets, and send out notifications to users when item prices are covered by budgeted amounts for those items. In one example, the price may be updated based on a lowest price of two or more prices that were retrieved from vendor(s).

In one embodiment, instance(s) of a shopping and budgeting system running on server(s) incorporate several of these features to allow users to interact with the graphical user interfaces for, automatically or by suggestion, purchasing particular items or items in particular categories once there are enough funds available to purchase the particular items or items in the particular categories. The system may help users make decisions of whether or not the system should make or suggest a purchase based on both (a) a potentially changing accumulated budget, and (b) a potentially changing item price.

The techniques described herein may be implemented by a shopping and budgeting system, as processes or steps that are performed by machines of the shopping and budgeting system, as non-transitory computer-readable media storing instructions that cause an instance of the shopping and budgeting system to perform the steps, or as computing devices, which are part of a shopping and budgeting system, that are specially configured to perform the steps.

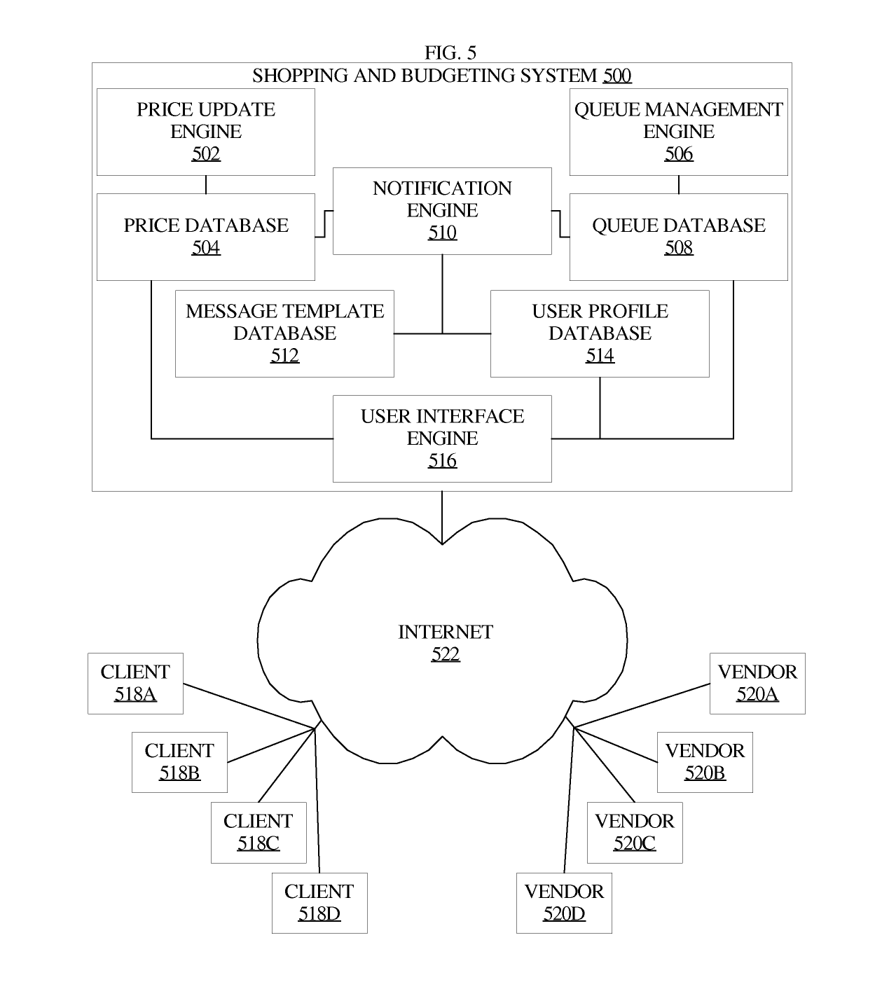

FIG. 5 shows an example shopping and budgeting system for updating prices based on information retrieved from vendors, and managing and monitoring queues modified by users. As shown, shopping and budgeting system 500 includes a price update engine 502 that stores up-to-date pricing information retrieved from vendors 520A-D in price database 504. Shopping and budgeting system also includes queue management engine 506 that manages queues created by users via clients 518A-D and funds added to those queues by clients 518A-D. The queues are persisted in queue database 508.

Notification engine 510 uses information from price database 504 and queue database 508 to determine which queues include items at the heads of the queues with updated prices that fit within the budgets associated with the queues. If notification engine 510 finds a queue with an item that fits within the budget for the queue, the notification engine 510 may follow the notification or purchase rules specified by the owner of the queue. These rules may be stored in user profile database 514 along with other user settings and preferences. The notification or purchase rules may be user-specific or even queue-specific.

If the rules indicate that notification engine 510 should notify the user that the item is within the budget for the queue, then notification engine may load a message template from message template database 512 to compose a message to the user. The notification engine 510 inserts, into the loaded message template, information specific to the item, vendor(s) listing the item, and/or the queue that triggered the notification.

Shopping and budgeting system also includes a user interface engine for generating user interfaces, such as HTML or Flash interfaces, that cause display of information to users via clients 518A-D. For example, the information for display may be retrieved from queue database 508 and price database 504. Display of the information may be customized according to user preferences specified in user profile database 514. The interfaces may also include various fields for accepting user input, and the user input may be used to modify information in user profile database 514 or queue database 508.

Shopping and budgeting system may communicate with clients 518A-D and vendors 520A-D by sending packets over the Internet 522, as illustrated, or over a more limited area network. Users may access the shopping and budgeting system 500 via clients 518A-D, such as smart phones, tablets, laptops, desktops, or other electronic devices. In one example, clients 518A-D cause display of structured information received from user interface engine 516 using a browser to interpret the structured information. As shown, shopping and budgeting system 500 is a single entity. However, shopping and budgeting system may include several instances of price update engines 502s, queue management engines 506s, notification engines 510s, and user interface engines 516s. These engines may operate in parallel on shared databases to process price updates from separate vendors and provide shpping and budgeting functionality for users via the clients.

### Authentication

The server(s) may also generate an authentication interface for logging into the shopping and budgeting system. The authentication interface may include fields for specifying authentication information such as a username, password, and/or pin code. Alternatively, this information may be pre-filled by the user's browser or by a password management system. Upon receiving authentication information that matches a stored user profile, the shopping and budgeting system may load user preferences, user account information, or other user-specific information from the user profile. The user preferences may affect how other interfaces are generated for the user, such as how other interfaces allow the user to specify budgets, select items, receives notifications, and/or complete purchases. The user account information may include information extracted or pulled from financial sources, optionally using at least some of the authentication information, about financial accounts owned and managed by the user. Other user-specific information may also be loaded, after authentication, to display information about previously defined budgets, previously selected items, and/or previously made purchases.

A user may log in to the shopping and budgeting system, via a Web browser, either explicitly by typing in a username, password, and/or pin code, or logging in through Facebook or Twitter, or implicitly by loading a cookie stored on the client that retains authentication information for the user. Alternatively, the user may shop without logging in to see items from various retailers without utilizing preferences or other user-specific information that may have been previously customized by the user.

In one embodiment, the shopping and budgeting system generates a setup interface that prompts a user for information about the user's discretionary income, or at least the user's discretionary income that is to be used for purchases on the shopping and budgeting system. The system may calculate the discretionary income by subtracting user-specified expenses from user-specified incomes, or the user may directly specify the discretionary income.

In one embodiment, the setup interface prompts the user for a savings method to be used for setting aside funds for purchases. The setup interface may include options for contributing funds to a gift card or pre-paid debit card, to a savings or checking account, or toward a credit card for which the user has set aside a monthly payment. These accounts may be managed by the shopping and budgeting system or through a partner of the shopping and budgeting system, or the shopping and budgeting system may access information about these accounts with third parties using user-provided authentication credentials. In another embodiment, the shopping and budgeting system relies on user updates about account status in order to keep budgeting information up-to-date.

In one embodiment, the setup interface prompts the user to split up the discretionary income into categories or queues. For example, the setup interface may include options for adding queues or deleting queues, and for assigning a portion of the discretionary budget or a set amount to the queues. In this manner, the budgeted amounts for the queues can change if the discretionary budget changes.

Features of the setup interface may also be provided on the budgeting and item selection interfaces, and vice versa. In this manner, a user may provide as much information up-front as desired, and may add information to the shopping and budgeting system as the user sees fit. Prompts for information about the user's account information and/or savings goals may be skipped at any time and filled in later or not at all.

### Budgeting Interface

During setup or after setup, the shopping and budgeting system may provide user options for creating new queues and adding budgets to those queues as users select items for potential purchase. If this option is selected while viewing information about an item, the shopping and budgeting system may create a queue, assign a user-specified budget to the queue, and add the viewed item to the queue. The system may also add a timeline for planned purchase of the item. A timeline may be created for an item if the user specifies a hard or soft deadline or due date for purchasing, shipping, and/or delivering the item, or any other time-related goal for saving up towards purchase of the item. Optionally, the timeline may delay the purchase of an item until the due date even after the user has accumulated enough funds to purchase the item.

Items may also be added to queues after queues have been created, and these items may replace current item(s) in the queue as the next item to be purchased by the budget designated for the queue. For example, a user may be saving up for a first item, such as a DVD player, in a home entertainment queue. As the user is saving up for the first item, the user may see a second item, such as a fancy remote control, that also fits in the home entertainment queue. If the user has specified that his home entertainment queue is a last-in-first-out queue, then the remote control may replace the DVD player as the next item to be purchased. The DVD player may be bumped behind the remote control for a later purchase. In another example, if the user specified that the home entertainment queue is a first-in-first-out queue, then the DVD player remains as the next item to be purchased because the DVD player already existed as the next item in the queue when the remote control was added.

In yet another embodiment, the user may specify a priority for the remote control when the remote control is added to the queue. If the user specifies a higher priority than the DVD player, then the remote control may replace the DVD player as the next item to be purchased. If the user specifies a lower priority than the DVD player, then the remote control may be added to the queue as an item to be purchased after the DVD player. If the user does not specify a priority or specifies a priority that is equal to the DVD player, then default rules for the queue such as last-in-first-out or first-in-first-out rules may apply.

In one embodiment, purchases are made by the shopping and budgeting system periodically in a manner that allows the user to add items to the queue over a period of time before any items are purchased, or to delay purchases until a specified time, or to postpone purchases from the queue by pausing the queue indefinitely until the queue is unpaused by the user. Pausing a queue may prevent the shopping and budgeting system from making any purchases and/or suggestions from the queue until the queue. For example, a user may pause queues related to luxuries or non-necessities in order to catch up on savings towards necessities. The shopping and budgeting system then purchases those items of highest priority as designated by the user, rather than exclusively purchasing those items that were added first, even if the budget was large enough to cover the items as they were added.

In one embodiment, each queue represents a shopping department or category. For example, a first queue may be designated for gasoline, a second queue for dining, a third queue for electronics, a fourth queue for a cleaning service, a fifth queue for outstanding loan debt, and a sixth queue for car insurance. Together, these queues may define an overall budget that the user has set aside for purchases or savings towards the categories.

In one embodiment, funds are maintained on a queue-by-queue, category-by-category, or set-by-set basis, rather than on an item-by-item basis. Money that is designated for specific queues may trigger alerts or purchases for highest priority items in those queues, and these highest priority items may change even before any alerts or purchases are made.

For example, the shopping and budgeting system manages, for a given user, a budget for sports equipment that has $100 as a currently designated amount towards sports equipment. In a first example, the sports equipment budget may have 4 items priced at $25 each. In this example, notifications or purchases may be triggered for all four of the items because they are within the budget for sports equipment. In a second example, the sports equipment budget has 4 items, 3 of which are priced at $25, and one of which is priced at $150. If the $150 item is first in the queue, then the budgeting system may stall notification or purchase of any of the items until the first item is within the budget. Alternatively, the budgeting system may only stall purchase of the other items, and may notify the user that there are affordable items in the queue. If the $150 item is second in the queue, then the budgeting system may notify the user that the first item in the queue is affordable, and/or the budgeting system may cause purchase of this item. The budgeting system may stall purchase or notification for the other items until they are within the budget in the specified order.

In one embodiment, a budgeting interface presents item prices visually in proportion to the budgets. For example, the budgeting interface may show a pie chart that illustrates a percentage of the item price that the current budget represents. When a different item is added to the front of the queue, the displayed percentages may change according to the price of the different item. Also, when funds are contributed to the budget, the displayed percentages may increase to account for the added funds. Although funds may be displayed as a portion of the item price, the funds might not actually be used until the item is purchased.

In one embodiment, a particular amount of funds that is designated for a particular set of items may be supplemented with additional funds from a flexible fund. The flexible fund may be used to fill in gaps needed for purchases of items from different sets of items. Such gaps may allow users to purchase items slightly earlier than the user would be able to purchase the items if the user had to wait until the designated amount for the set fully matured to the item price. Such gaps may also allow users to pay for unknown or unexpected costs, such as shipping and handling or processing fees. If there is no flexible fund, or if the flexible fund is inadequate to cover additional costs, these costs may come out of all or a subset of queues equally. Alternatively, these costs may be estimated and included as part of the item price.

Various embodiments of the shopping and budgeting system encourage healthy purchase planning instead of impulse spending. Instead of encouraging customers to buy on credit and then pay off the debt later, various embodiments of the shopping and budgeting system allow users to designate amounts of funds for specific purchases such that, whenever the transactions finally occur, these purchases are covered by funds that have already been saved or otherwise specially designated.

Various embodiments of the shopping and budgeting system automatically keep track of category-specific or set-specific budgets for users, and notify customers or trigger purchases or other actions when selected items or types of items enter into the user's budgets. Such a system would not require the user to keep track of budgets on paper or to make rough guesses that customers have such a poor track record making.

Such a system also does not require the user to keep revisiting various Web sites to check and compare latest prices. Various embodiments of the shopping and budgeting system automatically update pricing information for items, optionally based on multiple vendors of the items. The shopping and budgeting system may also compare prices from different vendors for same items, and provide users with a summary of the advantages and disadvantages, including price advantages and disadvantages, of selecting one vendor over other vendor(s).

Such a system also prevents customers from going over budget by pre-conditioning purchases of items based on amounts of money the customer has already saved towards the items. Instead of being alerted when the customer has exceeded the budget, the customer is pro-actively alerted by the shopping and budgeting system whenever an item is within the budget. In other words, customers using these features are prevented from making purchases until the customers have already designated funds for those purchases.

The shopping and budgeting system also prevents shopping cart abandonment. Many vendors treat unpurchased items as missed opportunities, and items may be removed from shopping carts after certain amounts of time. The shopping and budgeting system accommodates long-term purchase goals and ensures that items are not abandoned if the user is still saving for those items.

The shopping and budgeting system may force the user to prioritize purchases in same sets or categories of purchases. If the user's savings plan extends purchases of items in a queue or set beyond a threshold amount of time, the shopping and budgeting system may notify the user that many items in the queue or set are likely to never be purchased according to the current budget. The user may then adjust his or her queue accordingly to ensure that the most desired items are purchased within reasonable user-configurable timelines.

The shopping and budgeting system may also support user purchases by a certain date or time. The user may set timelines for purchases, and the shopping and budgeting system may keep track of user contributions to funds and notify the user when a given purchase is not on schedule for the specified timeline. When determining whether or not to notify the user, the shopping and budgeting system may allow for a user-configurable threshold variation in the amounts of contributions by the user. In other words, the shopping and budgeting system need not notify the user unless the user is over 10% behind schedule or under 5% ahead of schedule in saving up for an item.

In one embodiment, the budgeting interface may include an option for a user to set target dates such as birthday dates for which a savings goal, such as the purchase price of an item, should be achieved. A purchase may be accelerated by borrowing funds from other queues. Funds for a given item may be drawn out of other queues, out of all queues equally or at a specified percentage per queue, out of a flex queue, or as newly budgeted funds. Queues may include a user-specified flag that indicates whether or not the queue can be borrowed from. Queues may also include information about minimum periodic or accumulated budgeted amounts that should be dedicated to the queue. Upon or just prior to purchase, the system may present, on a user interface, information about how a purchase of an item, if funds are borrowed from other queue(s), affects timelines for affording other items in the other queues.

Unlike basic wish lists, the shopping and budgeting system accounts for and even takes actions based on current budgets for items. For example, if a budget covers the price of an item, the shopping and budgeting system may automatically notify a user of this fact. Alternatively, the shopping and budgeting system may automatically make a purchase of the item.

Saving up for an item based on a budget is quite different from purchasing an item at a target price. Even if a server was configured to notify a user when an item hit a target price, such as $100, the server would not add to the target price over time. For example, the target price would not be increased periodically by $50 a month or otherwise contributed to by the user. Also, a target price does not reflect funds that have been designated by the user for purchasing items from a set of items.

In layaway systems, customers pay vendors or sellers portions of the item price periodically until the full item price is met. In various embodiments of the shopping and budgeting system, customers are allowed to designate funds for sets of items without attaching the funds to any particular items in the sets. In fact, funds may even be designated for sets that do not yet have items in them. Using the shopping and budgeting system, customers may add items to or remove items from these sets as the customers are saving up for the items, without having to modify the funds that are designated for those sets.

In one embodiment, the shopping and budgeting system receives input defining or selecting a user-specific set of categories, such as those categories for which the user most frequently shops. In one embodiment, each category includes a list of zero or more user-selected items that can be rearranged according to a user-specified priority.

In one embodiment, the shopping and budgeting system automatically notifies the customer when the products are affordable within the budget for the category. Customer can set dates when they desire to afford items. In one embodiment, the shopping and budgeting system compares a user-specified date with a user-specified savings plan, such as a periodic contribution to a fund. If the user-specific savings plan cannot afford the item by the user-specified date, the user may be notified and may be asked to change either the date or the periodic contribution. In one embodiment, users are prevented from setting purchase goals that cannot be met by user-specified savings plans.

In one embodiment, the shopping and budgeting system provides an option for users to pause or slow down other categories in order to meet a timeline for a given category or item. For example, when the user specifies a savings plan and a timeline that do not match, the shopping and budgeting system may suggest other queues for which budget could be sacrificed in order to meet the timeline. If there are no other queues with surplus budgets, then, in one embodiment, the shopping and budgeting system may suggest deleting or pausing one or more queues, such as queues that have been designated by the user as non-essential queues.

In one embodiment, customer purchases are made outside of the shopping and budgeting system and reported, by the customer, to the shopping and budgeting system. In another embodiment, outside purchases are detected based on information about purchases that are analyzed from information associated with a user's credit card, checking, bank account, gift card, prepaid card, or e-wallet, such as an account statement or a list of recent account activity. For example, the information may identify recent purchases and/or funds or credit remaining for the account. The shopping and budgeting system may access this information using account credentials provided by the customer in an interface for setting up access to outside accounts.

In one embodiment, setting up shopping and budgeting preferences includes a variety of user-configurable parameters that can be gathered or modified at any time by the user on shopping and budgeting interfaces. A setup interface may appear when a user initially contacts a shopping and budgeting system. The setup interface may display a series of questions to help the user plan purchases and budget allocations. The user may select categories, specify amounts of funds to be designated to those categories, and specify other account information. For example, a user may select vendor categories, brands, stores, or products of interest, and this information may be used to form queues for the selected types of items. The setup interface may provide options to finalize or skip each request for information after the response has been fully completed, partially completed, or not completed at all. Information added by the user in the setup interface may be persistently stored in association with the user's account. This information may be used to make shopping suggestions for the user, to select or suggest queues, to manage user funding information, to maintain queues for the user, to manage automatic notifications and/or purchases for the user, or to maintain and use other user-specific preferences or settings. In one example, during setup, the user specifies brands or stores of interest, and the shopping system displays more browsing and/or searching options for these brands or stores than for other brands or stores not specified.

The setup interface and/or the budgeting interface provide options for specifying amounts that will be contributed, to queue(s) or to an overall budget, regularly or periodically according to a schedule or sporadically when contributions are made by the user. The user may also provide funding account information that specifies funding accounts from which funds are to be drawn to be contributed to the queues. Some budgets could be designated for shopping online, and other budgets could be designated for shopping offline, for a savings account, for recurring expenses, and/or for charity.

In one embodiment, customer financial information, which may detail amounts earned, amounts spent, and types of items purchased, is imported from an online financial advisor such as Mint, a credit card company such as American Express, or any other budgeting or financing software for which the customer has granted permission to access the customer financial information. In one embodiment, the third party software generates an XML document or other predictable format for exporting data, and the budgeting and shopping system imports this exported data into the budgeting and shopping system. The budgeting and shopping system may provide a financial analysis interface that provides information about customer spending and/or earning, and relates this information to customer-defined budgets. In one embodiment, the shopping and budgeting system instantiates an instance of third party financial software such as the Mint system based on user-provided credentials, such as a username and/or password, for accessing user information on this third party financial software. The third party software may provide information such as HTML pages that can be parsed to extract financial information specific to the user, such as recurring expenses, budget information, savings information, etc.

In one embodiment, a Yodlee service is used to access account information from various financial institutions, for example, by logging into financial institution systems. Based on financial information specific to the user that has been extracted from various financial sites or provided by the user, the shopping and budgeting system may perform a check as to whether the user is saving the appropriate amount each month. If the user is not saving the appropriate amount, the shopping and budgeting system may notify the user that the user is not on track towards a purchase goal. Such a notification may identify the item being saved for, the cost, and the recent funding, saving, or spending activity of the user.

In one embodiment, the shopping and budgeting system sends reminder notifications to the user to make manual contributions on the shopping and budgeting system. In another embodiment, the shopping and budgeting system supports automatic payments at scheduled times or periodically, or sporadically as the user sees fit. The shopping and budgeting system may hold money or may purchase debit cards, credit cards, or digital credits with a partner that can be spent by the user with online retailers and/or in physical stores.

In one embodiment, the shopping and budgeting system sends an email to a user that includes an option for the user to authorize a periodic payment that was set up according to a user schedule. If the user selects this option, the page containing the option triggers a reply message that causes the shopping and budgeting system to transfer an amount from a user account to an account associated with a budget for the subject queue(s).

In one embodiment, the budgeting interface provides information about savings progress towards purchasing items in queues. The status interface may concurrently display multiple queues towards which the user is saving, indications of how long it would take to complete the purchases of items in the queues at the current prices, indications of the percentages of the item prices that have already been saved, indications of the amounts of funds that have already been saved for the queues, indications of what discounts would be needed to purchase items from the queues, and options to move items between queues or rearrange items within a queue.

The budgeting interface may also provide information about a flexible fund that can be used to supplement funds in multiple queues such that purchases can be completed. The budgeting interface may include an option for using the flexible fund to purchase items in the queues, and an indication of how much money would be deducted from the flexible fund to complete the purchase. The flexible fund may also be used to pay for tax, shipping, and handling on purchases, which may or may not be included in the price.

In one embodiment, the budgeting interface also provides an option to borrow money from one queue to complete a purchase in another queue. The shopping and budgeting system may keep track of which queues have been borrowed from, and may display these results in the status interface and/or suggest changes based on actual purchase activity.

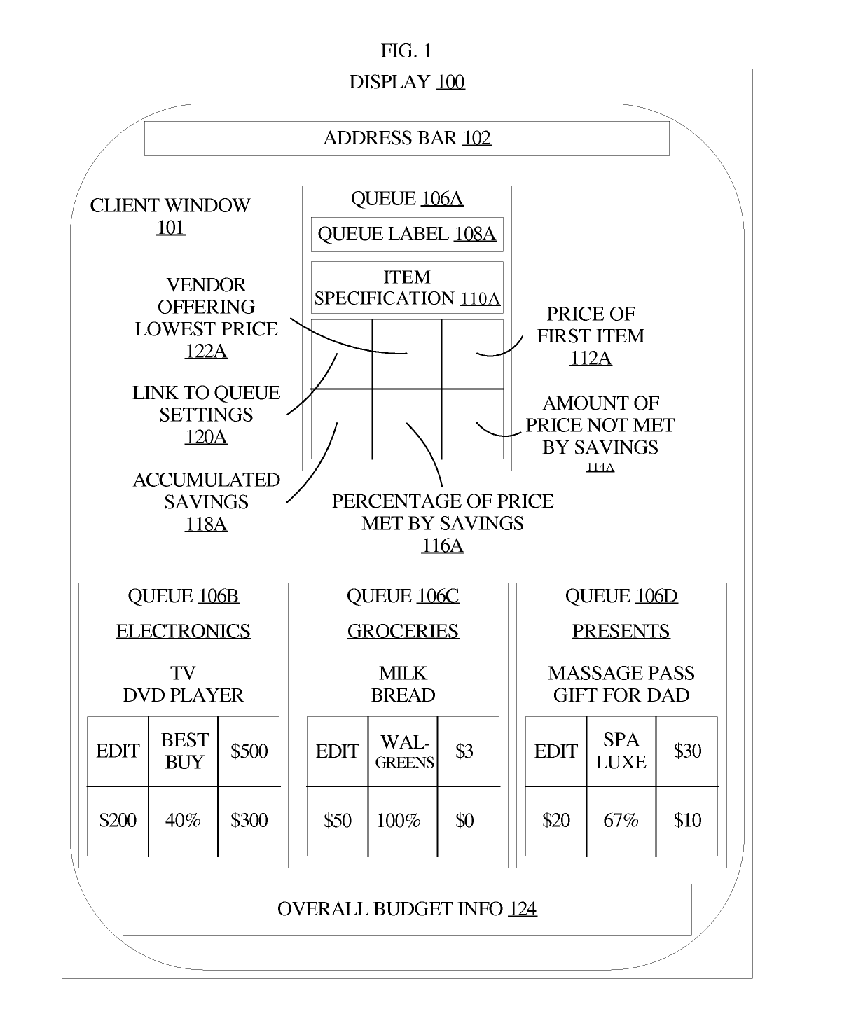

An example budgeting interface is illustrated in FIG. 1. FIG. 1 shows a display 100, such as a display on a client device. Display 100 includes client window 101 for displaying information received from the shopping and budgeting system. Address bar 102 places the client in contact with a server of the shopping and budgeting system, for example, via a URL of the server. Client window 101 concurrently displays information about multiple queues 106A-106D that are maintained at the server. A variety of information may be displayed about each queue to promote optimal utilization of the queues by the user. In the example, queues are shown with displayed queue labels 108A-D and item specifications 110A-D. The queue labels 108A-D provide basic name or summary information for each respective queue, and the item specifications 110A-D provide information, such as a name, serial number, or other characteristics or criteria about the items that are currently listed in the respective queues. Items may be dragged from one queue to another queue in response to drag-and-drop input from the user. Also, drag-and-drop input may cause items to be re-ordered within a single queue.

In the example of FIG. 1, each queue is presented with a variety of information about the queue. As shown, the regions for queues 106A-D present information about the prices of the first items in the queues 112A-D. The first item in a queue is the item that is next-in-line for purchasing. For example, the massage pass in queue 106D is $30, and the TV in queue 106B is listed at $500.

The regions for queues 106A-D also include amounts of prices not met by savings 114A-D. In other words, 114A-D display the amount of money that still needs to be saved for the queue in order to purchase the item. For example, $300 still needs to be saved in order to afford the TV in electronics queue 106B.

The regions for queues 106A-D also include percentages of prices met by savings 116A-D. If more than 100% of the item price has been saved, the region may display 100%, as illustrated in the region for queue 106C, or may display an option to purchase the item (not illustrated). As another example, $200 out of $500, or 40% has been saved toward the purchase of the TV in electronics queue 106B.

The regions for queues 106A-D may also include information about accumulated savings 118A-D for the respective queues 106A-D. For example, $200 has been saved for electronics in queue 106B.

The regions for queues 106A-D may also include links to queue settings 120A-D. These links may cause navigation to an interface for configuring notification settings for the queue, automatic purchases for the queue, default item-ordering schemes (such as FIFO or LIFO) for the queue, or other queue-specific information. Many of these settings may be set to be the same, by default, for all of the queues.

The regions for queues A-D may also include information about the vendor offering the lowest price 122A for the item at the head of the queue. For example, Best Buy is offering the lowest price for the TV in queue 106B, and Walgreens is offering the lowest price for the milk in queue 106C.

Regions for queues 106A-D may also include information about the periodic contribution that is set up for the queue, the next contribution to be made, the past purchases that were made in the queue, and any lists of owned items that are associated with the queue. The user may configure, in the queue settings interface or in a more general settings interface, which options and what information may be displayed in regions available for queues 106A-D.

Client window 101 may also include information about the overall budget in region 124. The information about the overall budget may include information about periodic user contributions of funds before such contributions are split up amongst the queues, total amounts saved up in all queues, and a list of purchases that are ready to be made (i.e., affordable) among all queues.

### Managing Customer Funds

In one embodiment, the shopping and budgeting system maintains designated funds in a system similar to SmartyPig, which is an online savings tool that incorporates social networking. In one embodiment, a savings goal is maintained in the online savings tool in association with a queue on the shopping and budgeting system. Although the savings goal does not identify a product, the product may be identified on the shopping and budgeting system based on which product is currently at the front of the queue. The shopping and budgeting system may check the online savings tool to see how much the user or his friends have contributed to the queue, and may make automatic notifications or purchases based on the amounts available in the online savings tool. In one embodiment, users provide credentials for accessing funds and/or account information in the online savings tool. In another embodiment, the online savings tool shares the account information with the shopping and budgeting system based on a user request to share the information.

Customers may receive cash boosts on the online savings tool from retailer partners such as Best Buy once they reach their savings goal. Customers may also receive cash boosts from retailers on the shopping and budgeting system by starting or completing a savings goal for a particular queue in which the retailer sells the item at the front of the queue. Funding techniques described herein may not currently be implemented by SmartyPig, but SmartyPig represents an example system that may be modified to complement some new funding techniques.

In one embodiment, the shopping and budgeting system maintains designated funds in a system similar to eLayaway, which allows customers to set up payment plans for specific products from a specific set of vendors. The shopping and budgeting system may be named as a specific vendor, and the product may be identified as the queue. The queue does not identify a specific product, but a layaway system may be used to save up for whatever product is currently at the front of the queue that is managed on the shopping and budgeting system. Funding techniques described herein may not currently be implemented by eLayaway, but eLayway represents an example system that may be modified to complement some new funding techniques.

In one embodiment, the shopping and budgeting system includes a mobile interface that is compatible with Android, Apple, Windows, and/or Blackberry smartphones. Customers using their smartphones may use the shopping and budgeting system to purchase real-world items in the store by paying with an online payment service that is supported by the shopping and budgeting system. For example, funds on supported payment services may be available via an email, a bump, or a scan of a smartphone. The shopping and budgeting system tracks purchases in different categories, and adjusts accumulated designated amounts accordingly. In one embodiment, the mobile interface includes an option to take a picture of a receipt. Based on the text of the receipt or a barcode printed on the receipt, information describing items on the receipt may be loaded into the shopping and budgeting system, and accumulated designated amounts may be adjusted accordingly based on this information.

### Automatic Credit Limit Adjustment

In one embodiment, if a funding source for a purchase is a credit card, the credit card service may increase the limit at a predictable rate each month up to a maximum approved amount, based on the amount that you did not spend in the previous month. For example, if you spent $40 out of a budgeted $50 in a month, then your credit limit would be increased by $10 to a total of $60 for the next month. However, such a system may require a significant amount of cooperation between the shopping and budgeting system, the credit card company, and the customer.

In an alternative embodiment, when a potential purchase is identified, such as by designating an amount of money for a queue, the shopping and budgeting system may place a hold for a pending purchase on the credit card. This hold may be refreshed by the shopping and budgeting system periodically, and the amount of the hold may be updated to account for saving activities by the user. For example, the user may specify a plan to save $500 for an item in the Electronics queue by saving $50 a month for the next 10 months. The credit card holder may be approved for a credit limit of $X+$500 such that the purchase can be made on the credit card if there are no holds on the card and no other balances on the card. In the first month, a hold of $X+$450 may be placed on the card such that the user only has $50 of credit available to spend.

If the user confirms that no other Electronics purchases were made in a given month, then the hold may be updated to reflect the savings made by the user during that month. For example, if no other Electronics purchases were made in the first month, then the hold may be updated to $X+$400 such that the user has $100 of credit available to spend rather than the original $50. The shopping and budgeting system does not need to manage the user's actual savings or checking account funds, but the shopping and budgeting system accepts the user's promise that the user is saving the budgeted amount (for example, $50 a month) towards the purchase. The shopping and budgeting system may also display how much the user would end up paying if the user completed the purchase on the credit card but only paid the saved amount plus the budgeted amount (for example, $50 a month) towards the credit card bill. Such information may highly discourage making impulse purchases before the full amount is saved.

If other Electronics purchases were made in a given month, then the hold on the credit card may be updated to reflect these other Electronics purchases. For example, if $60 of purchases were made in a second month after $100 had been saved towards an Electronics purchase, then $40 of existing budget and $50 of newly added funds would contribute to a new savings total of $90 rather than the $100 that was previously available on the card. In this example, a hold on the credit card could be increased from $X+$400 to $X+$410.

In another example, if $30 of Electronics purchases were made in the second month after $100 had been saved towards an Electronics purchase, then $70 of the existing budget and $50 of newly added funds would contribute to a new savings total of $120 rather than the $100 that was previously available on the card. In this example, a hold on the credit card could be reduced from $X+$400 to $X+$380.

Adaptive credit card holds such as these may be used for more than just an online shopping and budgeting system. Parents may use these types of holds for credit cards they have given to their kids to ensure that their kids do not spend more than they have saved in their savings account, or more than they have earned in allowance. In one embodiment, a hold management interface allows a user to verify that he or she is an owner of the credit card by verifying a charge that is placed on the credit card. The hold management interface may also allow the user, optionally once the card is verified, to maintain an effectively variable credit limit by adding, updating, or deleting a hold on the credit card. In one example, the user may add a $1500 hold on a card with a $2000 credit limit to ensure that no more than a $500 balance is accumulated on the card. The hold may be refreshed at default or user-configurable intervals for a default or user-configurable amount of time.

In one embodiment, the hold is automatically updated based on spending activity on the card or based on payment activity on the card. For example, spending an amount less than the available amount during a given period may case an automatic increase in the available amount (i.e., a decrease in the hold amount). The amount of the increase may be based on a difference between the available amount and the spent amount or based on the difference between a fixed amount and the spent amount. For example, a parent that provides a $50 monthly allowance to a child may choose to have the child's credit limit automatically increased by the difference between $50 and the spent amount for any month that the child spends less than $50 on the credit card. Similarly, the parent may choose to have the child's credit limit automatically decreased by the difference between $50 and the spent amount for any month that the child spends more than $50 on the credit card.

As another example, paying an amount above the minimum payment during a given period may cause an automatic increase in the available amount (i.e. a decrease in the hold amount). For example, if a parent may choose to increase a child's credit limit based on a difference between a paid amount and a set amount over the minimum payment. If the minimum payment is $10 and the set amount is $50, the child's credit limit may be effectively increased by $20 after the child makes a payment of $80 ($70 over the minimum) or decreased by $20 if the child makes a payment of $40 (only $30 over the minimum). The technique for increasing or decreasing the effective credit limit may be chosen based on whether or not there is a balance on the card at the end of a spending period and/or based on whether there was any activity on the card during the spending period.

### Item Selection Interface

Vendors provide shopping interfaces that allow users to search for and browse for items. Vendors may support searching and browsing features, and vendors may include, in the shopping interface, an “add to queue” button for adding item(s) to queue(s) of a shopping and budgeting system. The shopping and budgeting system may trigger purchase of, reservation of, or notification about the item(s) that are added to queue(s), based on whether the item(s) are within budget(s) designated for those queue(s).

A multi-vendor system may mine information about item(s) that are for sale by multiple online vendors, including vendors that serve as intermediaries between the manufacturers or sellers and the buyers. Information from different vendors may be displayed concurrently in a multi-vendor interface, optionally in response to a single action of browsing or searching. Unlike traditional intermediaries that require sellers to list items with the intermediaries according to an agreement between the intermediaries and the sellers, the multi-vendor system pulls information that is maintained on the shopping sites of other vendors without requiring those vendors to list the items as users of the multi-vendor system. For example, the multi-vendor system could pull information about electronics products that are for sale on bestbuy.com, frys.com, newegg.com, and amazon.com. These products could be displayed together on the multi-vendor interface in response to a user searching for or browsing for electronics products.

If the same item is listed by multiple vendors, the multi-vendor system may list, in addition to information about the item on the multi-vendor interface, information about the highest, average, or lowest prices, information about vendor-specific shipping and handling costs, or other information about vendor-specific incentives or vendor-specific ratings. If similar but distinct items are offered by different vendors, the multi-vendor system may list, in addition to information about the item on the multi-vendor interface, information that highlights, compares, or graphically indicates the differences between the items, information about the highest, average, or lowest prices, information about vendor-specific shipping and handling costs, or other information about vendor-specific incentives or vendor-specific ratings.

On a single interface, users may view items from different vendors, such as Amazon, Newegg, or eBay, or from the same vendor. The item selection interface includes options not only for viewing additional details about the items themselves, but for adding items to queues or categories. An item that has been added to a queue or category is recorded, by the shopping and budgeting system, in a set of items that are associated with a budget or a designated amount of money. This designated amount of money represents funds that the user has chosen to set aside for purchases of items in the set. A budgeting interface of the shopping and budgeting system includes options for the user to periodically, manually or automatically, or sporadically add funds to the amount of funds designated for the set. The shopping and budgeting system provides an option for the user to choose to use the added funds to purchase item(s) from the set when those item(s) become affordable within the designated amount of money. In other words, the shopping and budgeting system may provide an option for the user to purchase an item when the item price is covered by the designated amount for the set that contains the item. In one embodiment, the shopping and budgeting system sends payment reminders to users according to user preferences. For example, a user may request payment reminders one day before a manual periodic payment is due or one day before an automatic periodic payment is to be made.

Once an item has been selected for a potential purchase, the server may add the item to a queue that stores all of the items in the set. The queue may also be identified, based on a user-configurable option, as a first-in-first-out queue, a last-in-first-out queue, or any other type of queue that designates a priority among the items. In one embodiment, the user may specify an importance of the item when the item is selected, and the queue may order items based on importance. In a first-in-first-out queue, an earliest item added to the queue may be the first item that is purchased or the subject of a notification triggered by the queue. In a last-in-first-out queue, a latest item added to the queue is the first item that is purchased or the subject of a notification triggered by the queue. The server may await notification until the first item in the queue is within the budget (i.e., covered by the designated amount of funds for the queue), or may notify the user when any item in the queue is within the budget.

In one embodiment, a shopping interface or item selection interface may include a browsing feature and/or a searching feature. The item selection interface may provide options to filter or weigh results based on specified criteria. Example criteria may be suggested to the user, and optionally selected by the user. The example criteria may be specific to a category of items, and different categories may have different criteria. For example, in a camera browsing and/or searching interface, a user may specify a desired resolution in terms of pre-defined ranges of megapixels. Alternatively, the interface may provide a field for entering user-specified criteria that might not match any of the pre-defined criteria.

In one example, hard criteria may be specified by the user and received through an input field of the interface to search or browser for results that satisfy specified hard criteria, at the exclusion of items that do not satisfy the specified hard criteria. In this manner, the item selection interface supports filtering down the number of items by eliminating items that do not have required features. In another example, soft criteria may be specified by the user and received through an input field of the interface to search or browser for results with a preference for results that satisfy the soft criteria, without excluding results that do not satisfy the soft criteria. In this manner, the item selection interface supports a ranking of results based on preferences without the risk of excluding results that do not satisfy the preferences.

In one embodiment, the item selection interface accepts a combination of soft criteria and hard criteria. For example, the interface may have field(s) for receiving soft criteria that are graphically distinguished from field(s) for receiving hard criteria. In another example, a user may specify whether the criteria is required or merely preferred by selecting an option using a checkbox or a radio button adjacent to the field. Criteria may be soft criteria by default, with an option to change the criteria to “required” hard criteria.

The item selection interface may also provide an option for the user to add a current or last-performed search to a queue, or a current or last selected browsing category or selection to a queue. In this manner, queue entries might not be limited to single items, but may include type(s) of item(s) or set(s) of item(s) that satisfy criteria. Queue entries could also be single items that are identified by a product name, serial number, Quick Response (“QR”) code or other barcode, photo, video, set of features, manufacturer or producer, release date or date of manufacture, or other product identifying information or other item identifying information.

For example, a user may add, as an item to a queue, “any Xbox game that costs $10 or less and is not in a list of Xbox games that are owned by the user,” or an equivalent expression, or a logical combination of operators such as “game type=Xbox AND price<$10 AND NOT IN my-Xbox-list.” If this item is first in the queue, the item may trigger notification, by the shopping and budgeting system to the user, of any Xbox game that is $10 or less and is not in the list of Xbox games that are owned by the user. Alternatively, the shopping and budgeting system may automatically purchase, optionally after prompting the user via email for additional approval, any Xbox game that is $10 or less. The shopping and budgeting system may send these games to the user's default shipping address, and the user may start receiving unique Xbox games in the mail without searching for each unique game separately. Upon completing a purchase, the shopping and budgeting system may add purchased Xbox games to the list of Xbox games that are owned by the user.

In one embodiment, the item selection interface displays a single entry for each browsed or searched item, with different prices from different vendors, or multiple entries, one from each vendor, item, and/or price combination. In one embodiment, the item selection interface displays only a lowest price and an identity of a vendor that offers the lowest price. A list of other vendors that offer the item may be provided with or without including the listing price for those vendors. In one embodiment, vendors for an item are highlighted or listed at the exclusion of other vendors for the item when the vendors register to be listed, optionally paying a one-time or recurring fee to the shopping and budgeting system for the service of being listed.

In one embodiment, the item selection interface ranks results of searching or browsing based on item or vendor popularity or rating or price. Items ranked by popularity may appear higher up in results if the items appear in many queues of many users, if the items have been purchased by many users, and/or if the items appear in list(s) of most-sold items that are published by vendor(s).

Items may be split up into categories, queues, departments, or other containers or sets. The item selection interface presents items as a user searches for and/or browses the shopping and budgeting system. Information about an item, such as the item's title and price, may be displayed concurrently with an option to add the item to a queue or category. When an item is added to a queue or category, the server(s) may automatically place the item into a queue or category that has been associated with the item by the vendor and/or by the shopping and budgeting system, by default. The shopping and budgeting system may associate items with categories by mapping different vendor-specific categories to same or different shopping and budgeting system categories. The shopping and budgeting system may account for keywords or other information about the item to map the item to a shopping and budgeting system category. Alternatively, the server(s) may prompt the user to select a queue or category from a predefined set of queues or categories or specify a new queue or category.

The category may be determined based on the category that is used by the vendor(s) that list the item. For example, items from Amazon may fall under Amazon categories, and these Amazon categories may be mapped to shopping and budgeting system default categories or user-defined categories. This mapping may be stored and retrieved as needed. The mapping may be manually generated for default mappings, or may be suggested based on synonyms or definitions of the category names.

In one embodiment, a queue is automatically selected for an item based at least in part on categories, keywords, or other items associated with the queue and categories, keywords, or other items associated with the item. For example, an item may be in a vendor category of “Audio/Visual Equipment,” and this category may be mapped to an “Electronics” queue based on other items that are in the electronics queue. Some vendors or vendor categories may be manually mapped to default categories. For example, Best Buy and Frys products mostly fit into the Electronics category, and items from these industry-specific vendors may be added to a queue for that industry. If an item cannot be automatically mapped to a queue, an option may be presented to the user for selecting a category among a set of categories, or for specifying a new category. If an item is automatically mapped to a queue, the item selection interface may present an option to the user for re-mapping the item to a different queue, or for confirming the automatic mapping.

In one embodiment, machine learning techniques are used to optimize the mapping of items to queues. Item mapping logic may be presented with a number of variables, such as item name, vendor category, item price, item features or characteristics, keywords in item description, keywords in user comments about the item, other items suggested for purchase with the item by a given vendor, and/or a hard-coded mapping of the item to a category. Based on these factors, the item mapping logic selects a queue for the item. If the user re-maps the item to a different queue, the item mapping logic treats the initial mapping as a miss. If the user confirms the mapping or eventually purchases the item from the queue, the item mapping logic may treat the initial mapping as a hit. The item mapping logic may be configured to learn, based on an ongoing statistical analysis, the variables that are most relevant for mapping particular items on behalf of particular users. The mappings may be different for different users.

Some items may be compatible with multiple queues, but other items may be unique to a particular queue. If items match multiple queues, the item may be assigned to the queue with the highest priority, or the user may be prompted to select one of the matching queues. If queue is selected automatically, the user may be notified as to which queue the item was placed in and may be provided with a further option to change the automatically selected queue. The user may ignore this further option without requiring any additional clicks or other input by the user.

Items may be moved from queue to queue after they have been added to a queue, whether they are added to a queue by manual selection of the queue or automatic selection of the queue. For example, an item may be moved from “electronics” queue to a “dad's birthday” queue. In one embodiment, an interface provides an option to drag an item from one queue to another queue, or to select a different queue in a drop-down list of queues.

In a default mode such as first-in-first-out mode, an earliest item added to a queue may be the first item that is purchased or the subject of a notification triggered by the queue. The server may await notification until this item is within the budget, or may notify the user when any item in the queue is within the budget. Other modes, such as last-in-first-out mode, may be selected by the user. In last-in-first-out mode, a latest item added to a queue is the first item that is purchased or the subject of a notification triggered by the queue.

In one embodiment, the item selection interface includes an “add to queue” button, which, when selected, causes a viewed item to be added to a queue for a possible later purchase. The queue may be user-specified or automatically selected based on a default category or queue for the item. In one embodiment, third party vendors incorporate the “add to queue” button on their online shopping sites such that customers can add items to queues even when not on the item selection interface of the shopping and budgeting system.

In one embodiment, items may be grouped and added to a queue together. A user may add an item container to a queue, and the user may assign a label to the item container such as “New TV Setup,” which includes a new TV, audio/visual cords, and a TV mount. When adding an item to the queue, the user may add the item to this container within the queue. In another embodiment, secondary item(s) may be added to a planned purchase of a primary item, without creating a separately labeled container to hold the items.

The item selection interface may present an option to purchase the secondary item at the same time the primary item is purchased. If a set of items are selected to be purchased together, the shopping and budgeting system may treat the set of items as a single item with an aggregate price of all of the items in the set. In the example, the shopping and budgeting system would not cause a notification or purchase action for the new TV until the budget covers the new TV, the audio/visual cords, and the TV mount.

In one embodiment, adding an item to a queue from a vendor site causes the vendor information to be retained in the shopping and budgeting system. The shopping and budgeting system might not notify the user of other vendors that sell the same product unless the user requests this additional information. Automatic notifications and purchases may be based on the vendor-specific information rather than information about prices from different vendors.

In one embodiment, vendors or sellers may pay for use of the “add to queue” button on their sites, for display next to products listed on their sites, in exchange for helping their customers plan purchases for high-end items. Vendors or sellers may also agree, in exchange for the added customer base, to favorable return policies for automatic purchase options and automatic notification options. The vendor or seller may pay per click or as a commission on the percentage of sales.

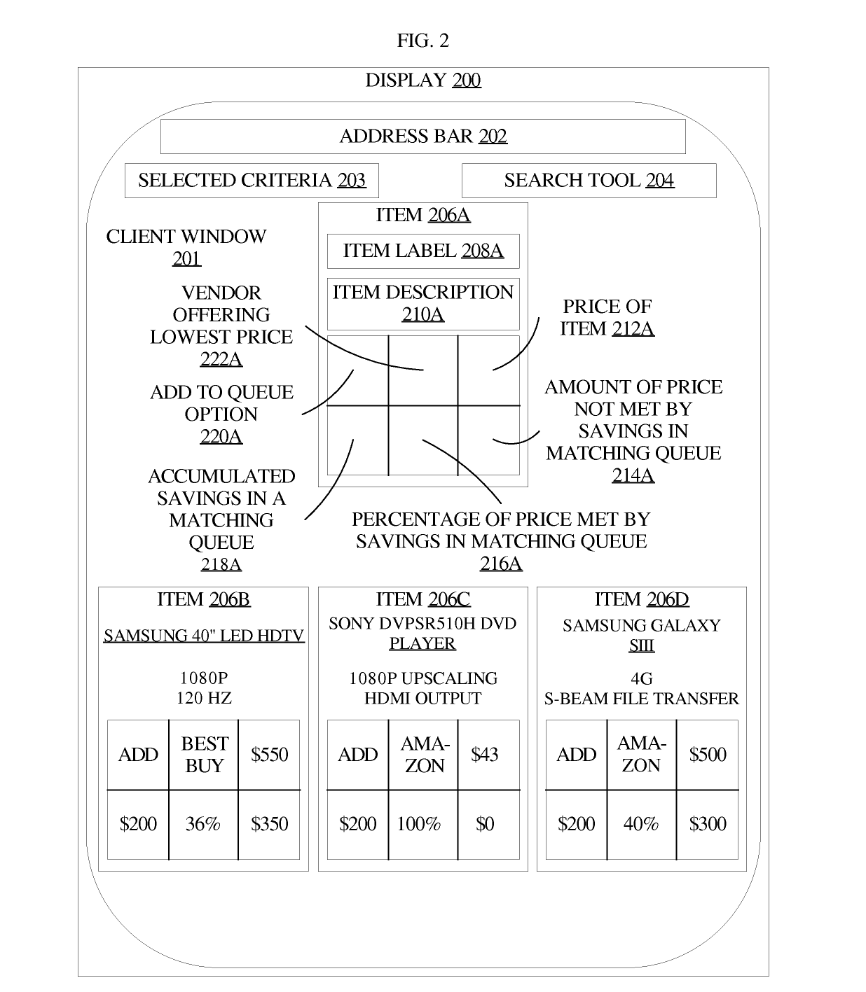

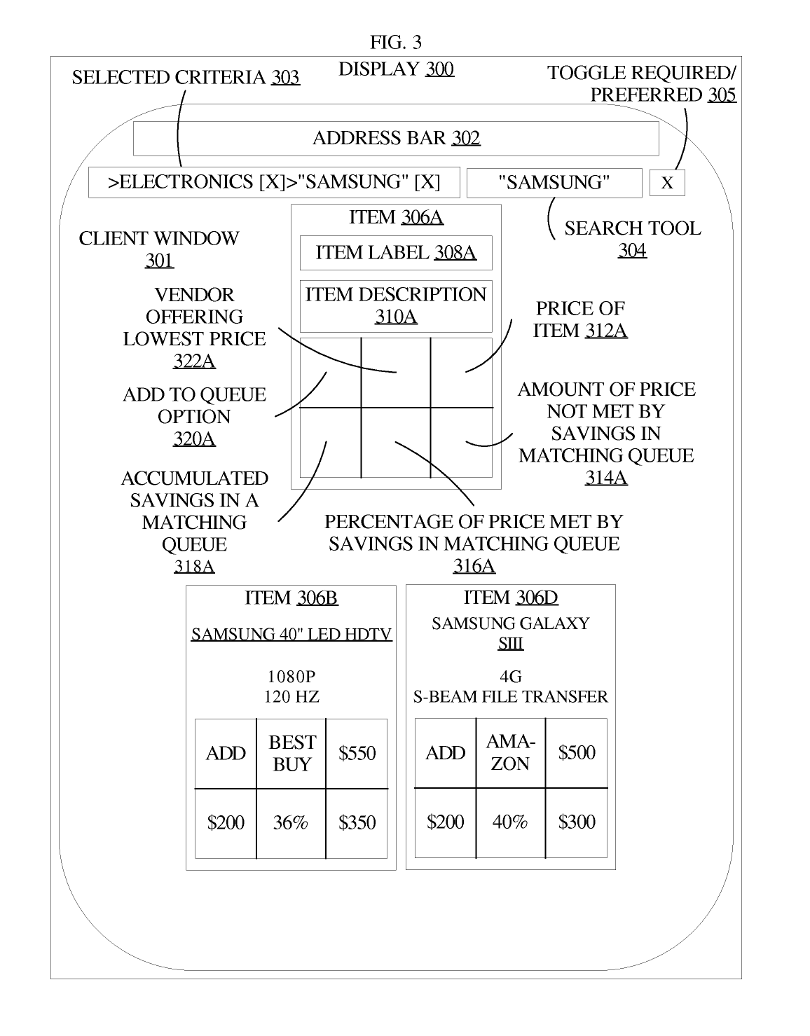

FIGS. 2-3 illustrate example interfaces for browsing, searching, and/or selecting items to be added to queues. As shown, client window 201 includes selected criteria for narrowing down and prioritizing items that are being browsed or searched. Client window 201 also includes search tool 204 for specifying keywords that are associated with target items, and client window 201 may also include a list of categories (not illustrated) for the target items. By selecting categories and entering search terms, a user may narrow down and prioritize items to find a desired item for adding to a queue.

As shown, client window 201 includes information about items 206A-D displayed in regions for items 206A-D. In the example, items 206A-D include item labels 208A-D and item descriptions 210A-D. Item labels 208A-D may provide name or summary information, and item descriptions 210A-D may provide additional information. For example, the label for item 206D is Samsung Galaxy SIII, and the description lists features of the item, such as “4G” and “S-Beam File Transfer.”

The regions displaying information about items 206A-D may also include prices of items 212A-D. The prices 212A-D may be, for example, the lowest listed prices among several vendors for items 206A-D. For example, the Samsung Galaxy SIII is listed for $500 on Amazon.

The regions displaying information about items 206A-D may also include information about the amounts of the prices that are not met by savings in matching queues 214A-D. For example, if item 206B were added to an electronics queue that already includes $200 of savings, then an additional $350 would still be needed to afford item 206B, which is listed for $550 on Best Buy.

The regions displaying information about items 206A-D may also include information about the percentages of prices that are met by savings in the matching queues 216A-D. For example, if the Samsung Galaxy SIII were added to the electronics queue with $200 of savings, then 40% of the price would already be available. This information may indicate, to the user, how much more would have to be saved before the item could be purchased from that queue.

The regions displaying information about items 206A-D may also include information about accumulated savings in the queues matching the items. For example, the items being browsed and searched in FIG. 2 fit into the electronics queue that has $200 of funds already saved.

The regions displaying information about items 206A-D may also include options for adding the items to the matching queues 220A-D. Upon adding an item to a matching queue, the user may be prompted with an option to change the queue to which the item is added. For example, the Samsung Galaxy SIII could be changed to a Phone Upgrade queue rather than the default Electronics queue.

The regions displaying information about items 206A-D may also include information about vendors offering lowest prices for the items 206A-D. For example, Amazon offers the lowest price of $43 for the DVD player item 206C.

In FIG. 3, additional search criteria of “Samsung” has been entered in search tool 304. Also, a selection has been made on the checkbox 305 to indicate that the search term is required. Selected criteria 303 shows that the user is browsing for an item in the electronics category and searching for an item associated with the “Samsung” keyword. The X's that appear in the selected criteria 303 are user-selectable options to remove criteria from the selected criteria 303.

### Retrieving Price Information

Servers of the shopping and budgeting system may periodically retrieve price information from vendors. Such information may be retrieved by parsing Web pages of vendors, by downloading product lists and price lists that are made available by vendors, or even by manual entry of such information.

In one embodiment, vendors generate marked-up documents such as HTML documents, XML documents, or other documents with predictable formats, and the budgeting and shopping system may automatically import information extracted from these documents according to the expected formats into the shopping and budgeting system. The budgeting and shopping system may periodically retrieve price updates from vendors by parsing refreshed versions of these documents. Alternatively, the shopping and budgeting system may receive price updates from vendors as prices are changed. In one embodiment, the shopping and budgeting system may retain latest price information for use in evaluation of whether to send automatic notifications or make automatic purchases for queues of multiple users. The shopping and budgeting system may discard latest price information once these evaluations have been made, or the shopping and budgeting system may retain latest price information until such information is replaced by even newer information.

Notifications and/or Automatic Purchases

In one embodiment, the shopping and budgeting system may notify a user of price changes for item(s) in a queue, or when item(s) transition into or out of the budgeted amount for the queue. Alternatively or additionally, the shopping and budgeting system may automatically purchase item(s) at the head of the queue if the item(s) transition into the budgeted amount for the queue.

The shopping and budgeting system may provide default notification or purchasing conditions, and the user may customize these conditions using a notification or purchase setup interface.

In various embodiments, conditions for notification or automatic purchase for an item in a queue may be based on any combination of one or more of the following: an identity of the item including features, characteristics, genre, a category or type of the item, release date, whether the item is new or used, a condition of the item, serial numbers, or keywords associated with the item; and/or other information including: a price of the item, the budget for the queue that contains the item, whether or not the item is offered by specified vendor(s) (for example, a condition may save for a purchase at Calvin Klein), a discount amount or percentage for the item, a price of the item as a percentage of the budgeted amount for the queue, whether or not the item price is within the budget, whether or not the item has already been purchased or queued, whether or not the item has been purchased or queued by the user or the user's friends or other contacts (optionally accounting for only user-selected friends) within a period of time (such as the last N years, months, days, weeks, or hours), how many items of a same type have been purchased or queued by the user or the user's friends or other contacts within a period of time, whether or not the item is in a set of items that the user or the user's friends or other contacts already own, whether the item is trending (among all users or optionally among only the user's friends or other contacts), popularity of the item among the user's friends or contacts (among all users or optionally among only the user's friends or other contacts) in terms of frequency that the item has been purchased or queued, and/or the recency of purchasing or queuing of the item, reviews or ratings of the item (among all users or optionally among only the user's friends or other contacts), suggestion(s) of the item by friend(s), occurrences or mentions of the item in posts from social networks such as Facebook or Twitter in terms of number of posts, number of mentions, or number of unique users mentioning the item (among all users or optionally among only the user's friends or other contacts), occurrences or mentions of the item in news articles, blogs, reviews, or other Web sources, whether or not the item is the last item in stock among all vendors or for a specific vendor, how many items are left in stock among all vendors or for a specific vendor, and/or whether the item has already been purchased by the user or another user for a gift recipient. The conditions for notification may be based on information gathered from purchases or selections made on the shopping and budgeting system itself and/or on the purchases or selections made on other vendors. The conditions may also account for lists, such as popularity lists or favorites lists, that are distributed by other vendors or friends or other contacts.

Also, the shopping and budgeting system may trigger different actions for a same item under different conditions, optionally triggering multiple purchases or notifications for the same item, or limiting a number of purchases or notifications for the item to a discrete number, such as one or two.

In one example, you may commit to buy any 4+ star peer-rated DVD movie, rated by more than 50 other users, that you and a group of selected friends do not already own, as long as it is $5 or less. Such a condition may be stored as “average_rating>4 AND movie type=DVD AND number_of_ratings>50 AND NOT IN myDVDlist AND NOT IN groupDVDlist.” In the example, when DVDs are purchased by friends in the group, the friends may agree to share such purchases by selecting an option to allow their DVD purchases to be added to the groupDVDlist. When a condition is based on a list of purchased or owned items maintained for a group of users, the shopping and budgeting system may notify the entire group that a single user intends to purchase a particular item and add the item to the list. This rule may prevent multiple users from purchasing duplicate items for the group's list.

The shopping and budgeting system may include a condition analysis engine that periodically analyzes conditions, analyzes conditions at user-specified times, and/or analyzes conditions asynchronously whenever changes related to the conditions are detected. A change is related to a condition if the condition references a variable that was subjected to the change. A condition may be satisfied when a stored logical expression evaluates to TRUE. When a condition is satisfied, the shopping and budgeting system performs a responsive action.

The responsive actions performed by the shopping and budgeting system may be user-configurable in the notification or purchase setup interface. The responsive action may include generating or retrieving a message and causing transmission of the message over a network. The message may be a notification message that is sent to the user to notify the user that the condition has been satisfied. Such a message may include an identity of the item, the vendor, the price, an item description, a sale or discount period, a current budgeted amount for a queue that contains the item, a list of other items that are in the queue, and/or prices or information about the other items.

The notification message may also include an option, such as a button or link, that, when selected, causes a responsive message to be sent. The option may indicate whether or not a purchase of the item is desired by the user. If the option is selected to indicate that a purchase is desired, code embedded in the notification message may cause automatic generation of a responsive purchase order directed to a vendor in a format expected by the vendor to complete a purchase of the item. The responsive purchase order may automatically include, based on information from the user's profile that is embedded in the notification message or retrieved using a secure connection with a server, any information, such as financing information and shipping information, that may be required or desired by the vendor to complete the purchase. The notification message may also include addressing information for the vendor such that the purchase order can be transmitted to the proper location. In this manner, the user may authorize a purchase, which was automatically initiated by a stored condition, by providing a single instance of user input such as a single click or a single touch to select the option. In one embodiment, instead of automatically generating a purchase order, the notification message may include embedded code for starting a Web session with the vendor to complete a purchase of the item, optionally with user-specific and/or item-specific information pre-loaded on a Web page.

If an option in the notification message is selected to not purchase the item or to remove the item from the queue, then the option may cause the notification message to generate a responsive message to be sent to the shopping and budgeting system. The responsive message may cause the shopping and budgeting system to keep the item in the queue or remove the item from the queue, depending on the selection.

In one embodiment, instead of or in addition to sending a notification to the user, the shopping and budgeting system may automatically send a purchase order to a vendor or seller of the item. In this embodiment, the satisfaction of a condition may cause an automatic purchase of the item. The purchase order may include, based on information from the user's profile, any information, such as financing information and shipping information, that may be required or desired by the vendor to complete the purchase. The user may be notified, if at all, when the condition is satisfied but before the purchase is made, as the purchase is being made, after the purchase has been made but before the item has shipped, after the item has shipped, and/or after the item, if tracked, should have arrived.

In one embodiment, the shopping and budgeting system makes suggestions or completes purchases of recurring item(s), such as paper, toner, pens, pencils, or other items that are user-specified as items used for normal business activities. The user may specify a period of time after which these items should be added to the front of an office supply or recurring item queue. When the items are purchased, the period of time may be reset. Upon expiration of the time period again, the items may be added to the front of the queue and purchased again.

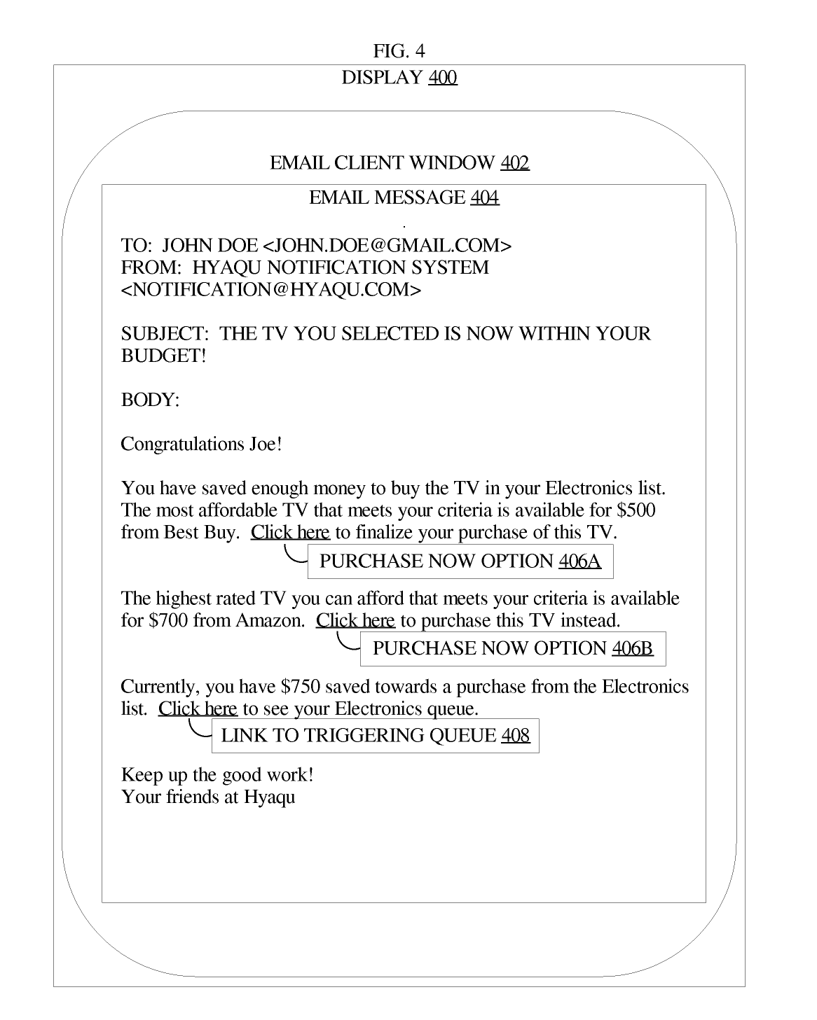

FIG. 4 illustrates an example notification message to a user who added an item to a queue. In FIG. 4, email client window 404 displays an email message 404 that was automatically generated by a shopping and budgeting system and received from the shopping and budgeting system. The email message 404 is addressed to the user, John Doe, and includes two options 406A and 406B to purchase items that match the user's criteria in the triggering queue. In the example, the message lists the most affordable item that matches the user's criteria, and the best rated item that matches the user's criteria. The email may include Javascript or a secure link such that, when the user selects option 406A, a purchase of the most affordable item is finalized. Similarly, if the user selects option 406B, a purchase of the best rated item is finalized. The user may also select link 408 to view the triggering queue, such as an Electronics queue, in more detail. The user may then re-organize items in the queue, add items or funds to the queue, and/or remove items from the queue.

### Checkout

In one embodiment, when items in a queue become affordable within the budget of the queue, the shopping and budgeting system may automatically purchase the products on behalf of the user and/or notify the customer that the item is within the budget. The shopping and budgeting system may not require the user to navigate through a full shopping cart process before the item is purchased. If the item is purchased automatically, the system may not require any input or even communication with the user in order to complete the purchase. If user authorization is required to purchase the item, which may be indicated by the user via a notification or purchase setup interface, the system may send a message to the user that requires as little as a single item of user input to authorize the purchase. For example, the message may be an email message with a button that is clickable or tappable by the user to complete the purchase. The message may be a text message to which the user can respond to complete the purchase. The message may be transmitted as a phone call from an automated operator that verbally conveys the information and listens for tones or speech authorization.

In one embodiment, when the shopping and budgeting system causes the purchase of an item, whether automatically or manually, the shopping and budgeting system may perform a verification step to verify that the user has the recorded amount of funds in their account. For example, the recorded amount of funds may be based on a last-retrieved balance of a user's credit or debit card account, or based on a user-reported amount, and a final check is made to ensure that the balance in the account covers the price of the item and any other costs such as shipping and handling.

In one embodiment, the notification or purchase setup interface includes an interface for authorizing automatic purchases of items. Such an interface may display warnings to users about how purchases will be made, and the user may specify limits on the number of automatic purchases that can be made and the amounts that can be spent on automatic purchases. For example, the user may allow only one unconfirmed purchase at a time. The user can confirm that a purchase was correct by providing input to the shopping and budgeting system, such as a response to a message or a selection made on a confirmation prompt while navigating within the shopping and budgeting interface, before or after the purchase is completed. Upon confirming that a purchase was correct, the system may proceed to make another purchase on behalf of the user. If the system receives input that indicates a purchase was incorrect, the system may prompt the user with an option to return the item that was automatically purchased and/or an option to change the automatic purchase settings.

### Resale of Used Items

In one embodiment, the shopping and budgeting system includes a resale interface for automatically re-listing purchased items. For example, a video game, a DVD, or a book may be automatically re-listed a month after the item was purchased. The resale interface may include options for selecting the types of items that should be automatically listed for re-sale, the amount of time that the system should wait to re-list the item, the percentage of the purchase price that the item should be re-listed by default, the percentage of the average or lowest sale price of the item, as listed by other sellers, that the item should be re-listed by default.

In one embodiment, a suggested re-listing price is based on market activity for the item. For example, a suggested re-listing price may be increased for items that have high sales and/or high queue activity among potential buyers, and/or low stock among potential sellers. Conversely, a suggested re-listing price may be decreased for items that have low sales and/or low queue activity among potential buyers, and/or high stock among potential sellers. In one embodiment, the shopping and budgeting system notifies a user that an item could be re-listed based on the user-specified settings. The notification message may include information about the item, information about other sellers' or vendors' listings of the item, and/or an option to re-list the item. For example, the shopping and budgeting system may send a message to the user with information about re-listing the item, including a proposed re-list price. In one embodiment, the system awaits confirmation in response to the message that the item should be re-listed, for example, based on user-selection of a “re-list now” button. The confirmation may also include updated price information. In response to receiving the re-list message, the shopping and budgeting system may re-list the item for sale.

The shopping and budgeting system may further be configured to notify the user about offers or agreements to purchase the item by other buyers, such notifications including information about the other buyers' names and addresses. Upon a completed transaction for a re-listed item, funds may automatically be deducted from a buyer's account and deposited into a seller's account, optionally after deducting a fee that may be charged by the shopping and budgeting system.

In one embodiment, a user is notified if, after purchasing the item, based on the market activity for the item, the item could be resold for a profit. For example, books may become in more demand at the beginning of fall or spring semesters, and book prices may increase at those times.

Example Interactions with the Shopping and Budgeting System

In one embodiment, the shopping and budgeting system is used by online shoppers to reserve funds, setup notifications, and make purchases for goods, services, or activities. The online shoppers may be purchasing items for which the shopping and budgeting system is the seller, items for which the shopping and budgeting system is an intermediary that allows sellers to list items, and/or items for which information has been retrieved from other vendors who are listing the items, either as sellers or as intermediaries. The buyers may browse and search items in the shopping and budgeting system and/or on other vendors' sites, and may complete the purchases in the shopping and budgeting system or on other vendors' sites.

In one embodiment, banks and financial systems may use the shopping and budgeting system to help customers pay off credit card debt or save for items in a personal financial management arena.

Customers may access the shopping and budgeting system on mobile devices to pay for items that fit in their queues, and to limit spending only to the budgets allotted to those queues. For example, if a user designated $30 for Gasoline, the user could use their mobile device to deduct the $30 from their account to pay for the gasoline at a gas station. If the user was in Home Depot, the user could use funds saved for Home Improvement to pay for purchases that fit within the Home Improvement category.

In one example, a customer may scan items with a mobile application on a smartphone to calculate a total price of the products in the shopping and budgeting system. The customer may compare the total price of the products with the budgets allocated for products of those types in the customer's queues. For example, if a customer's budget for grocery shopping is $100, the app would alert the customer once the customer has met or exceeded $100 for the items in the physical shopping cart. The user may prioritize among the items to be purchased at the grocery store and add remaining items that are desired to a groceries “queue” for later purchase.

In various embodiments, the shopping and budgeting system may serve physical purchases or virtual purchases. The virtual purchases may be made for virtual items to be used by a physical person or virtual items to be used by a virtual character controlled by the physical person. In one embodiment, a user is able to instantly purchase a virtual item in a virtual world by placing a corresponding physical item in a queue for purchase in the physical world. For example, a user may purchase a virtual bicycle for a virtual character upon placing a physical bicycle in the user's queue for later purchase. In one embodiment, users could save up for virtual items by saving points rather than money. The items may be automatically purchased, or the user may be automatically notified, when the user has enough points allocated to a budget that includes affordable items.

### Budget Contribution and Sharing on a Social Network

In various embodiments, users may share information about their queues with friends that use the shopping and budgeting system. Users may share as much or as little information as desired. The shopping and budgeting system may provide updates about user queues in news feeds on social networking sites, if permitted by the user. The shopping and budgeting system may also permit users to find their friends from Facebook, LinkedIn, or other social networks, on the shopping and budgeting system, once the user has provided credentials or agreed to share cached information with the shopping and budgeting system. Once connected in the shopping and budgeting system, users may contribute to others' queues and ensure that their purchases complement purchases by friends and family.

In one embodiment, dollar amounts of individual items, and possible the identity of the individual items, are hidden when queues are shared to friends. For example, a user may see that his or her friend is saving for Electronics, and that his or her friend is 40% complete with a goal in the Electronics queue, but the user might not see which Electronics item the friend is saving for. Similarly, the dollar amount of the money saved for the queue, and other budgeting information, such as the amount and frequency in which the friend has committed to contributions, may be hidden.

In one embodiment, the shopping and budgeting system allows users to define groups with different access privileges. The shopping and budgeting system may cause different views to be displayed for different people in different groups. For example, some friends may see some queues, and other friends may not.

In one embodiment, the shopping and budgeting system provides an interface that accepts contributions, from a user, of funds towards an item on a wish list or queue of a friend or another user. Funds contributed by the friend, the user, and others of the user's friends may be aggregated, by the shopping and budgeting system, towards a total price of the listed item.

In one embodiment, item(s) may be shared between users through the shopping and budgeting system, either in a shared queue, or as shared item(s) that may reside in separate queues for different users. For example, friends may save up together for songs, albums, movies, or video games. As another example, a husband and wife may save up together for groceries, for house cleaning services, or for a family vacation.

The shopping and budgeting system may provide an option to share a queue between users, and to specify privileges for the queue being shared. Different users may have the same or different privileges to add items, remove items, or otherwise modify the queue, and the same or different obligations with respect to funding the queue. For example, a parent may share a queue with a child, and the parent may take most of the funding responsibility for the queue and maintain the ability to add funds to the queue. The shopping and budgeting system may also allow the parent to specify, via an interface, whether adding items to the queue or purchasing items from the queue requires approval by the parent, and whether the parent can add items to and/or remove items from the queue with or without approval by the child.

Users sharing a queue may concurrently or non-concurrently modify the queue, and the shopping and budgeting system may synchronize the queue for the users that have access to the queue. If one user submits a modification to the queue while another user is still modifying the queue, the shopping and budgeting system may notify the other user that his or her version of the queue is out of date. The shopping and budgeting system may prevent the other user from submitting further changes until the queue is refreshed, or the shopping and budgeting system may allow the other user to submit further changes even though the queue has not been refreshed. When the queue is refreshed, either manually or automatically, changes to the queue made by another user may be reflected in the queue that is displayed to the user by the shopping and budgeting system.

Users sharing individual item(s) may store those item(s) in different queues, and the item(s) may be removed from the respective queues when any of the users purchases the item(s). For example, one college roommate may place a shared “microwave” item in a “move-in” queue, and another roommate may place the shared item in a “school supplies” queue. If a first user has requested to share an item with a second user, the shopping and budgeting system may notify the second user, via an email to be accessed from an external email client or via a notification within the shopping and budgeting interface, with a notification. The notification may contain an option for the second user to select or create a queue to which the shared item should be added. Upon completion of the option, the shopping and budgeting system adds the shared item to the queue of the second, with a stored indication that the item is shared with the first user. The shopping and budgeting interface may provide options for sharing a budget for the item, for dividing the cost of the item in a user-specified manner, or for allowing the item to be purchased in full amount by either user. If the cost of the item is divided in a user-specified manner, one user may be notified when another user has successfully saved for his or her portion of the item, but, optionally depending on the user preferences, the shopping and budgeting system may delay purchase of the item until all users have saved up for their respective portions.

In one embodiment, items in a shared queue or shared items are updated as items are purchased, and users having access to the items can see the updates, through the shopping and budgeting system, as they occur. For example, a user may scan a barcode of an item, in a shopping and budgeting system mobile application, before, after, or during purchase of that item at a store, and the item may be marked as purchased or pending purchase in the shopping and budgeting system. Any other users viewing the item may receive an update, from the shopping and budgeting system, that the item has been purchased or is being purchased by the user. In another example, the shopping and budgeting system may display, in association with an item, an option that allows a user to manually mark the item as purchased or pending purchase from an online vendor. The option may also include input fields for specifying price information, shipping information, and date of purchase information. In yet another example, the shopping and budgeting system automatically updates items that are purchased through the shopping and budgeting system or through a partner vendor.

### Vendor and Advertiser Interface

In one embodiment, vendors and advertisers may pay for a membership fee to gain access to information about customer queues and items included in those queues. The customer identities may be hidden from the vendors and advertisers, but other information, such as budgets and items in those budgets, may be made available to the vendors and advertisers.

In one embodiment, a multi-vendor shopping and budgeting system compares prices and items from different vendors. The multi-vendor shopping and budgeting system may sell advertising space to advertisers using pay-per-click ads or ads based on user traffic. The multi-vendor shopping and budgeting system may also offer referrals to venders or sellers for product placement or suggestion to customers of the multi-vendor shopping and budgeting system. The multi-vendor shopping and budgeting system may also charge vendors, sellers, or buyers a small cost per transaction for providing shopping and budgeting services.

In one embodiment, an advertiser and vendor interface displays information about customer queues. For example, advertisers and vendors may see what items and/or categories customers in different regions or of different age ranges are saving for. Vendors may view or be notified of the progress that customers are making towards saving for their items. Customer queue information may be anonymized by aggregating the queue information into different demographics. Demographic categories may be hidden from advertisers or vendors or grouped with other demographic categories if the demographic categories do not include at least a minimum number of customers that would provide anonymity.

Advertisers or vendors may select, in the advertiser and vendor interface, options to display discounts or other advertisements to customers. For example, vendors may offer discounts to customers that have saved for at least 50% of the cost of one of their items. Other conditions regarding the progress of customer savings, the amount of customer spending, and/or the amount a customer is periodically contributing to budgets may also trigger advertisements or discounts. As another example, advertisers may display ads targeted to customers who actively maintain certain types of queues, such as Electronics queues. In one embodiment, a vendor may choose an option to change a price of an item to an amount that reflects how much customers, on average, are budgeting for items of the same type.

In one embodiment, a customer is notified by the shopping and budgeting system when an advertiser chooses to adjust a price for an item that is in a queue for which the customer is saving. The notification may be sent to the user without revealing, to the advertiser or vendor, an identity of the user or contact information for the user. The user may activate or deactivate these types of notifications.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

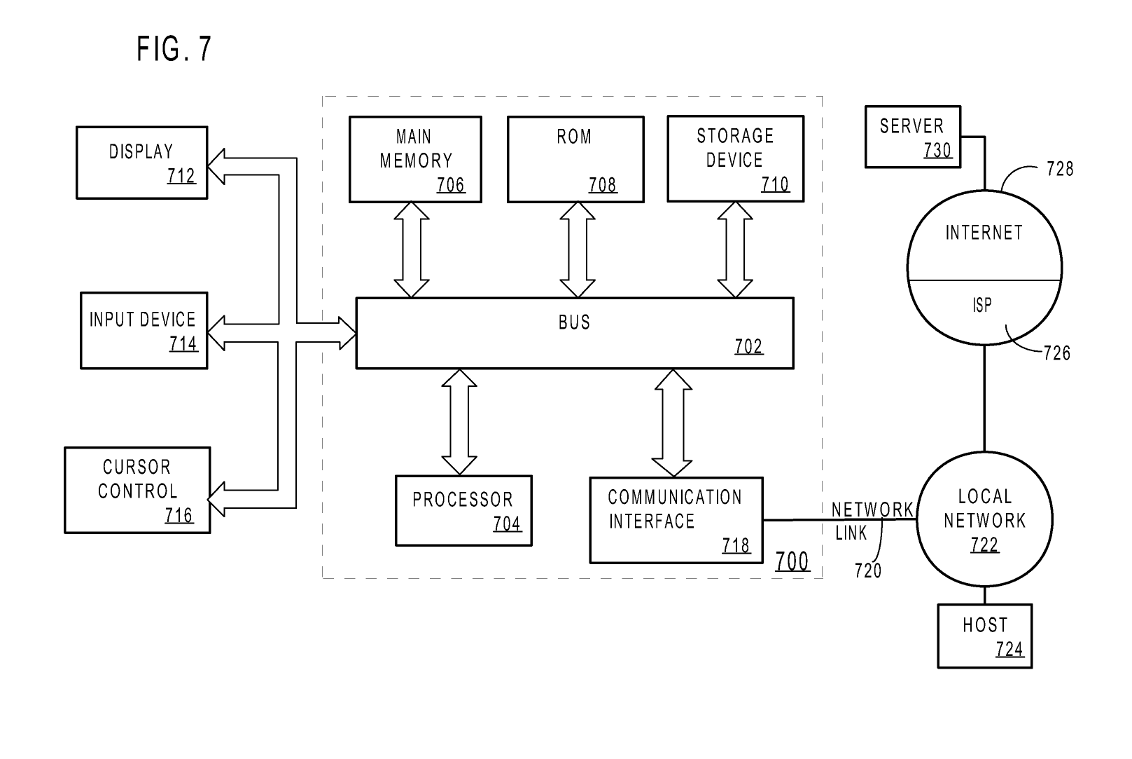

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
electronically storing, in association with a set of one or more items of potential expenditure by a user:
an item specification that describes at least one item, and
an amount of funds that has been designated by the user for the set, wherein the amount does not initially cover a price of the item;
updating the amount or the price;
based at least in part on the updating, detecting that the amount covers the price;
in response to detecting that the amount covers the price of the item, generating and sending an electronic message that identifies the item and the price;
wherein the method is performed by one or more computing devices.

2. The method of claim 1, wherein the electronic message is sent to the user as a notification that the amount covers the price of the item.

3. The method of claim 2, wherein the electronic message includes an option to purchase the item at the price, wherein the option, when selected, causes purchase of the item at the price.

4. The method of claim 1, wherein the electronic message is sent to a vendor of the item as a purchase order for the item at the price.

5. The method of claim 1, wherein the amount of funds is updated according to a user-specified periodic contribution of funds to the amount, wherein the amount as updated includes funds from multiple occurrences of the periodic contribution of funds.

6. The method of claim 1, further comprising receiving a user-generated request to add funds to the amount, and wherein the amount of funds is updated in response to receiving the request.

7. The method of claim 1, further comprising retrieving price information from one or more vendors, and wherein the price is updated based at least in part on the retrieved price information.

8. The method of claim 1, further comprising retrieving two or more prices from one or more vendors, and wherein the price is updated based on a lowest price of the two or more prices.

9. The method of claim 1, wherein the item specification comprises one or more criteria for selecting the one or more items from a plurality of items listed by one or more vendors.

10. The method of claim 1, wherein the item specification identifies a particular item listed by a particular vendor.

11. The method of claim 1, wherein the set of one or more items includes user-selected items that fit in a particular shopping category.

12. The method of claim 1, wherein the set of one or more items includes user-selected items that have been added to a user-selected category.

13. The method of claim 1, wherein the one or more items of potential expenditure are user-selected goods from a plurality of goods listed by one or more vendors of the plurality of goods.

14. The method of claim 1, wherein the one or more items of potential expenditure are user-selected services from a plurality of services listed by one or more vendors of the plurality of services.

15. The method of claim 1, wherein the one or more items of potential expenditure are user-selected activities from a plurality of activities related to a plurality of vendors.

16. One or more non-transitory storage media storing instructions which, when executed by one or more computing devices, cause:
electronically storing, in association with a set of one or more items of potential expenditure by a user:
an item specification that describes at least one item, and
an amount of funds that has been designated by the user for the set, wherein the amount does not initially cover a price of the item;
updating the amount or the price;
based at least in part on the updating, detecting that the amount covers the price;
in response to detecting that the amount covers the price of the item, generating and sending an electronic message that identifies the item and the price.

17. The one or more non-transitory storage media of claim 16, wherein the electronic message is sent to the user as a notification that the amount covers the price of the item.

18. The one or more non-transitory storage media of claim 17, wherein the electronic message includes an option to purchase the item at the price, wherein the option, when selected, causes purchase of the item at the price.

19. The one or more non-transitory storage media of claim 16, wherein the electronic message is sent to a vendor of the item as a purchase order for the item at the price.

20. The one or more non-transitory storage media of claim 16, wherein the amount of funds is updated according to a user-specified periodic contribution of funds to the amount, wherein the amount as updated includes funds from multiple occurrences of the periodic contribution of funds.
